(19) United States
(12) Patent Application Publication
(10) Pub. No.: US 2008/0111289 A1
(43) Pub. Date: May 15, 2008

(54) Wave spring

(75) Inventor: Takeshi Matsumura, Minato-ku (JP)

Correspondence Address: JORDAN AND HAMBURG LLP, 122 EAST 42ND STREET, SUITE 4000, NEW YORK, NY, 10168, US

(73) Assignee: MATSUMURA KOHKI CO., LTD., Minato-ku (JP)

(21) Appl. No.: 11/595,043

(22) Filed: Nov. 10, 2006

(51) Int. Cl. F16F 1/00

(52) U.S. Cl. 267/71

(57) ABSTRACT

A wave spring, in which a multiply annularly wound spring comprises a wave portion in which peaks and troughs are alternately formed in a winding peripheral direction and a ring-like mounting portion that is substantially flat in the winding peripheral direction, with an inner periphery or an outer periphery of the mounting portion being mounted upon engaging with an outer periphery or an inner periphery of an member to be mounted, wherein the outer periphery or the inner periphery of the mounting portion is provided with an engaging urging portion which enables engagement through elastic contact with respect to a radial direction.

### BACKGROUND OF THE INVENTION

1. Field of the Invention

The present invention relates to a wave spring also comprising retaining ring functions with respect to a member to be mounted.

2. Description of the Related Art

A technique as disclosed in Japanese Patent Laid-Open Publication No. 2004-225880, which has been filed and published earlier by the applicant of the present application, is known as a conventional wave spring.

This wave spring is obtained, for instance, by multiply winding and fastening a strip-like spring material in a coil-like manner to which a ring-like mounting portion exhibiting retaining ring functions is integrally formed. Such a conventional wave spring exhibits, in addition to basic functions of applying snapping force in a winding axis direction of the spring member, positioning functions, and it is also possible to mount the same to an axis or a hole.

### SUMMARY OF THE INVENTION

It is an object of the present invention to provide a wave spring of enforced retaining ring functions with respect to a member to be mounted.

For achieving the above object, the present invention is arranged, in summary, as a wave spring in which a multiply annularly wound spring comprises a wave portion in which peaks and troughs are alternately formed in a winding peripheral direction and a ring-like mounting portion that is substantially flat in the winding peripheral direction, with an inner periphery or an outer periphery of the mounting portion being mounted upon engaging with an outer periphery or an inner periphery of an member to be mounted, wherein the outer periphery or the inner periphery of the mounting portion is provided with an engaging urging portion which enables engagement through elastic contact with respect to a radial direction.

The engaging urging portion might be arranged in that the spring is made to project towards the inner periphery or the outer periphery at suitably portions of the mounting portion.

The engaging urging portion might be provided at an end portion and/or an intermediate portion of the mounting portion of the spring.

The wave portion and the mounting portion might be of mutually different winding radii.

The mounting portion might be formed by winding the spring by a plurality of times.

In this case, the mounting portion might be arranged in that each winding radius of the spring differs from time to time.

Moreover, the mounting portion might be formed at any one of one end portion, an intermediate portion or both end portions of the spring.

Further, a circling mounting groove might be formed on the inner periphery or the outer periphery of the member to be mounted such that the mounting portion is mounted to the mounting groove.

The spring might be formed of a strip-like base material.

According to the present invention, the mounting portion is provided with an engaging urging portion at an outer periphery or inner periphery of a member to be mounted that enables engagement through elastic contact with respect to a radial direction so that the mounting portion of the wave spring can be mounted to an axis or a hole of a member to be mounted in the absence of a groove through the elastic contacting action that is provided by the engaging urging portion. It is accordingly possible to provide a wave spring of enforced retaining ring actions with respect to a member to be mounted.

### BRIEF DESCRIPTION OF THE DRAWINGS

FIG. 1(A) is a plan view of a wave spring according to a first embodiment of the present invention and FIG. 1(B) is a side view thereof.

FIG. 2 is an explanatory view showing one example of mounting the wave spring according to the first embodiment of the present invention.

FIG. 3(A) is a plan view of a wave spring according to a second embodiment of the present invention and FIG. 3(B) is a side view thereof.

FIG. 4 is an explanatory view showing one example of mounting the wave spring according to the second embodiment of the present invention.

FIG. 5 is a plan view of a wave spring according to a third embodiment of the present invention.

FIG. 6 is a plan view of a wave spring according to a fourth embodiment of the present invention.

FIG. 7(A) is a plan view of a wave spring according to a fifth embodiment of the present invention and FIG. 7(B) is a side view thereof.

FIG. 8(A) is a plan view of a wave spring according to a sixth embodiment of the present invention and FIG. 8(B) is a side view thereof.

FIG. 9(A) is a plan view of a wave spring according to a seventh embodiment of the present invention and FIG. 9(B) is a side view thereof.

FIG. 10 is a side view of a wave spring according to an eighth embodiment of the present invention.

FIG. 11 is an explanatory view showing an example in which two members to be mounted are elastically coupled using wave springs according to a ninth embodiment of the present invention.

FIG. 12 is a side view of a wave spring according to a tenth embodiment of the present invention.

FIG. 13 is an explanatory view showing another example in which the wave spring according to the first embodiment of the present invention is mounted to a mounting groove provided on an inner peripheral wall of a member to be mounted.

FIG. 14 is an explanatory view showing another example in which the wave spring according to the second embodiment of the present invention is mounted to a mounting groove provided on an outer peripheral wall of a member to be mounted.

### DESCRIPTION OF THE PREFERRED EMBODIMENTS

A plurality of embodiments related to the wave spring of the present invention will now be explained in details while referring to the drawings. In this respect, in explaining the plurality of embodiments according to the present invention, component members that are common to the plurality of embodiments are basically marked with the same reference numerals (however, where discrimination is required for sake of explanation, branch numerals might be affixed to the common reference numerals), and duplicated explanations thereof will be omitted. In such instance, discussions will be focused on differences between the formerly explained embodiment and the latterly explained embodiment.

Technical elements that are common to the plurality of embodiments will first be discussed. The wave spring according to the present embodiment is basically formed by, for instance, winding a strip-like base material by a plurality of times in an annular manner. Such a base material might be a metallic material or a non-metallic material exhibiting elasticity and rigidity corresponding to those of metal. Among metallic materials, SWRH72B, SUS304 and SUS631J1 or the like can be suitably used.

### First Embodiment

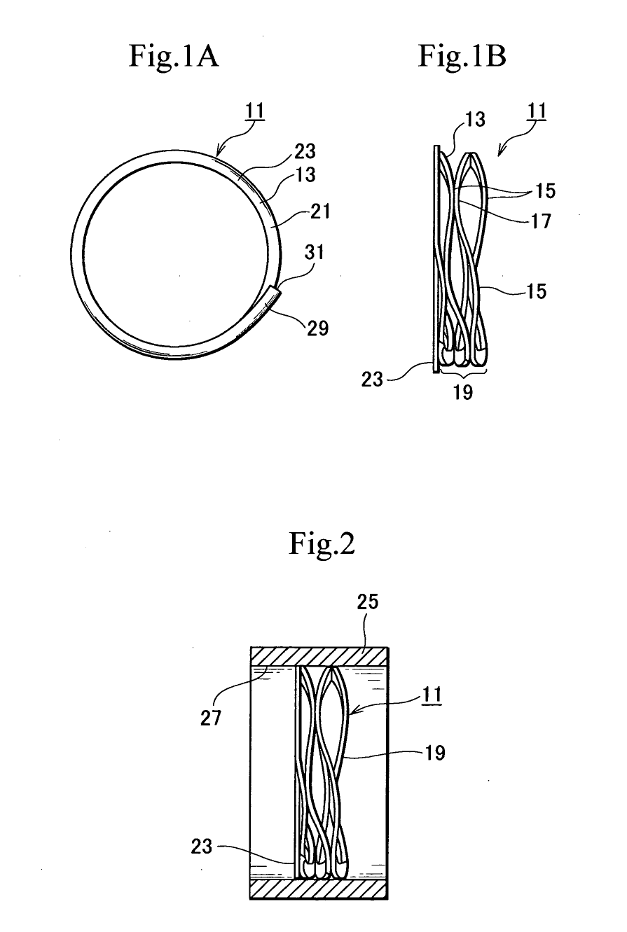

The wave spring 11 according to the first embodiment is arranged, as shown in FIGS. 1(A), 1(B) and 2, in that a spring 13 annularly wound by a plurality of times is provided with a wave portion 19 in which peaks 15 and troughs 17 are alternately formed in a winding peripheral direction and a mounting portion 23 formed with a substantially flat ring-like portion 21 in the winding peripheral direction.

The wave portion 19 is arranged in that a plurality of waves (waveforms) of substantially constant frequency is formed along the winding peripheral direction. Where a single round of winding is defined as a layer, the wave portion 19 includes a base layer adjoining the mounting portion 23 and a plurality of upper layers that sequentially adjoin the base layer in the axial direction. At the wave portion 19, top points of the peaks 15 of the waves belonging to the base layer on the mounting portion 23 side and bottom points of the troughs 17 of the upper layer adjoining the bottom layer are in contact with each other. The outer diameters of the respective layers of the wave portion 19 are defined to be substantially uniform. In this respect, the size of the waveforms of the waves can be freely selected within a range that satisfies the above-mentioned contact condition between the peaks 15 and troughs 17.

The mounting portion 23 is formed by winding the spring 13 by substantially one round. The outer diameter of the mounting portion 23 is formed to be slightly larger than the outer diameter of the wave portion 19.

The wave spring 11 according to the first embodiment is mounted in that the outer periphery of the mounting portion 23 engages while elastically contacting an inner peripheral wall 27 of a cylindrical hollow axis 25 which is an object of mounting. For this purpose, the mounting portion 23 is provided with an engaging urging portion 29 that enables engagement with the inner peripheral wall 27 of the member to be mounted 25 through elastic contact in the radial direction. The engaging urging portion 29 might be formed by making the spring 13 project in the outer peripheral direction at suitable portions of the mounting portion 23. In the first embodiment, one engaging urging portion 29 is formed by bending an end portion 31 of the spring 13 of the mounting portion 23 in the outer radial direction with respect to the mounting portion 23.

The wave spring 11 according to the first embodiment is mounted to, for instance, the hollow axis 25 that comprises the member to be mounted. For mounting, the outer radius of the mounting portion 23, particularly the engaging urging portion 29 is shrunk and moved or pushed along the inner peripheral wall 27 of the member 25 up to a specified mounting position. When it is released at the mounting position, the engaging urging portion 29 elastically bits into the inner peripheral wall 27. Through this biting, the outer periphery of the mounting portion 23 is mounted upon engaging with the inner peripheral wall 27 of the member to be mounted 25 while elastically contacting the same.

According to the first embodiment, since the engaging urging portion 29 elastically bits into the inner peripheral wall 27 of the hollow axis 25 that comprises the object of mounting, the mounting portion 23 can be fixed without saccadic movements while preventing rotation of the wave spring 11 around the axis.

### Second Embodiment

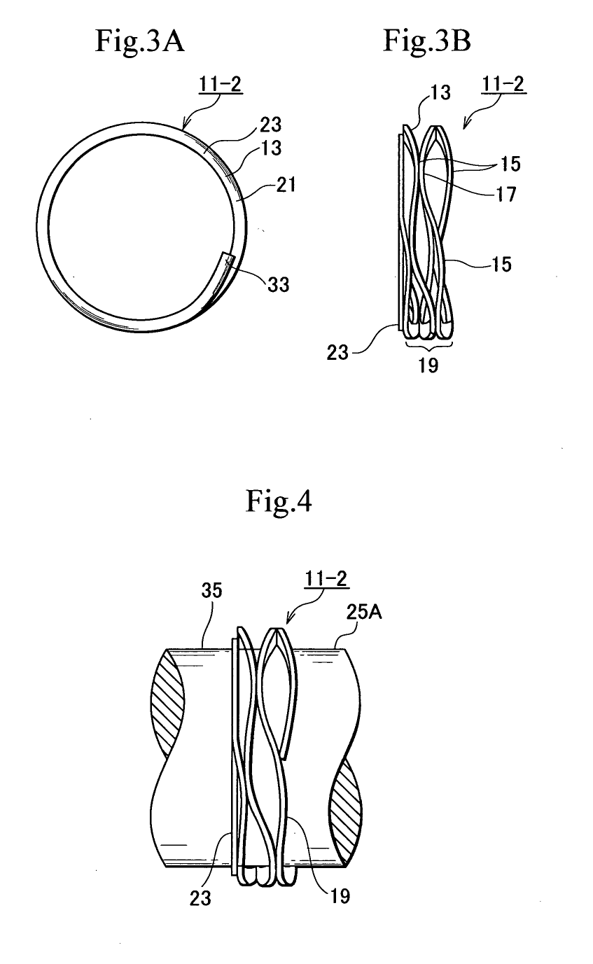

While the wave spring 11 of the first embodiment is mounted in that the outer periphery of the mounting portion 23 engages with the inner peripheral wall 27 of the cylindrical hollow axis 25 that comprises the object of mounting while elastically contacting the same, the wave spring 11-2 according to the second embodiment is mounted in that the inner periphery of the mounting portion 23 engages with an outer peripheral wall 35 of the axis 25A that comprises the object of mounting while elastically contacting the same as shown in FIGS. 3(A), (B) and 4. In other words, the wave spring 11-2 according to the second embodiment is mounted to the axis 25A while including the axis 25A. For this purpose, the outer radius of the mounting portion 23 is arranged to be slightly smaller than the inner radius of the wave portion 19.

The mounting portion 23 is provided with an engaging urging portion 33 that enables engagement with the outer peripheral wall 35 of the member to be mounted 25A through elastic contact with respect to the radial direction, similar to the first embodiment. More particularly, in the second embodiment, one engaging urging member 33 is formed by bending an end portion 31 of the spring 13 of the mounting portion 23 in the inner radial direction with respect to the mounting portion 23.

When mounting the wave spring 11-2 of the second embodiment to the outer periphery of the axis 25A, the inner periphery of the mounting portion 23, particularly the engaging urging portion 33 is expanded and moved or pushed along the outer peripheral wall 35 of the member 25A up to a specified mounting position. When it is released at the mounting position, the engaging urging portion 33 elastically bits into the outer peripheral wall 35. Through this biting, the outer periphery of the mounting portion 23 is mounted upon engaging with the outer peripheral wall 35 of the axis 25A while elastically contacting the same.

According to the second embodiment, since the engaging urging portion 33 elastically bits into the outer peripheral wall 35 of the axis 25A that comprises the object of mounting, the mounting portion 23 can be fixed without saccadic movements while preventing rotation of the wave spring 11-2 around the axis.

### Third Embodiment

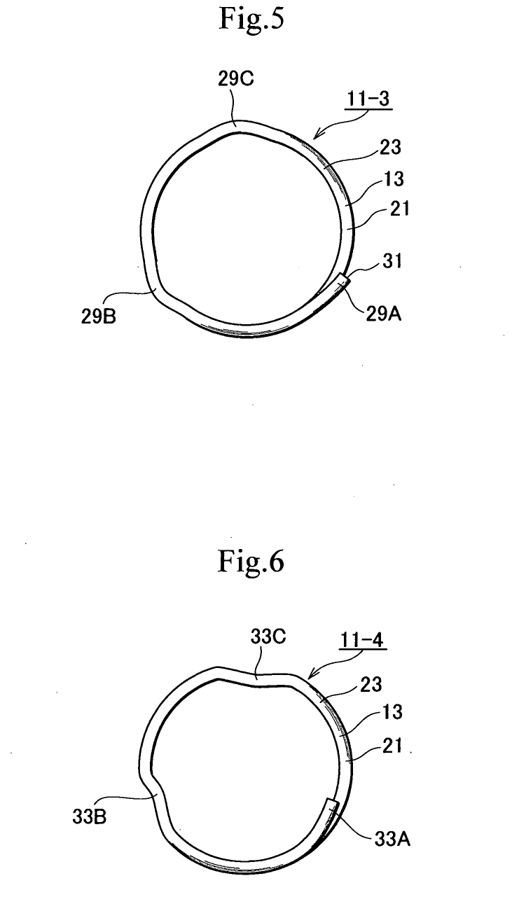

The wave spring 11-3 according to the third embodiment is an improvement of the engaging urging portion 29 according to the first embodiment upon varying its setting position and setting number for the purpose of further improving retaining ring functions which is to be achieved by the present invention. That is to say, the wave spring 11-3 according to the third embodiment is arranged in that three engaging urging portions 29A, 29B and 29C are provided at substantially constant intervals along the peripheral direction with respect to the mounting portion 23 as shown in FIG. 5. More particularly, the above-mentioned three engaging urging portions 29A, 29B and 29C include one formed by bending an end portion 31 of the spring 13 of the mounting portion 23 towards the outer radial side as indicated by reference numeral 29A and those formed by bulging two portions that are apart from the end portion 31 by specified distances towards the outer radial side as indicated by reference numerals 29B, 29C. Such bulging can be formed through press molding prior to winding the strip-like base material. However, it might also be formed simultaneously with the winding.

In this respect, while the third embodiment has been explained on the basis of an example in which the three engaging urging portions 29A, 29B and 29C are arranged at substantially constant intervals along the peripheral direction with respect to the mounting portion 23, several approaches are possible for realizing the retaining ring enforcement functions that are to be achieved by the present invention. That is to say, it is possible to increase the setting positions and setting numbers of the engaging urging members 29. Further, the above-mentioned degree of bulging can be increased. It is moreover possible to employ an arrangement which is a combination of the above. Such modifications are accordingly included in the technical scope of the present invention.

### Fourth Embodiment

The wave spring 11-4 according to the fourth embodiment is an improvement of the engaging urging portion 33 according to the second embodiment upon varying its setting position and setting number for the purpose of further improving retaining ring functions which is to be achieved by the present invention. That is to say, the wave spring 11-4 according to the fourth embodiment is arranged in that three engaging urging portions 33A, 33B and 33C are provided at substantially constant intervals along the peripheral direction with respect to the mounting portion 23 as shown in FIG. 6, similar to the third embodiment. More particularly, the above-mentioned three engaging urging portions 33A, 33B and 33C include one formed by bending an end portion 31 of the spring 13 of the mounting portion 23 towards the inner radial side as indicated by reference numeral 33A and those formed by denting two portions that are apart from the end portion 31 by specified distances towards the inner radial side as indicated by reference numerals 33B, 33C. Such denting can be formed through press molding prior to winding the strip-like base material. However, it might also be formed simultaneously with the winding.

In this respect, while the fourth embodiment has been explained on the basis of an example in which the three engaging urging portions 33A, 33B and 33C are arranged at substantially constant intervals along the peripheral direction with respect to the mounting portion 23, several approaches are possible for realizing the retaining ring enforcement functions that are to be achieved by the present invention. That is to say, it is possible to increase the setting positions and setting numbers of the engaging urging members 33. Further, the above-mentioned degree of denting can be increased. It is moreover possible to employ an arrangement which is a combination of the above. Such modifications are accordingly included in the technical scope of the present invention.

### Fifth Embodiment

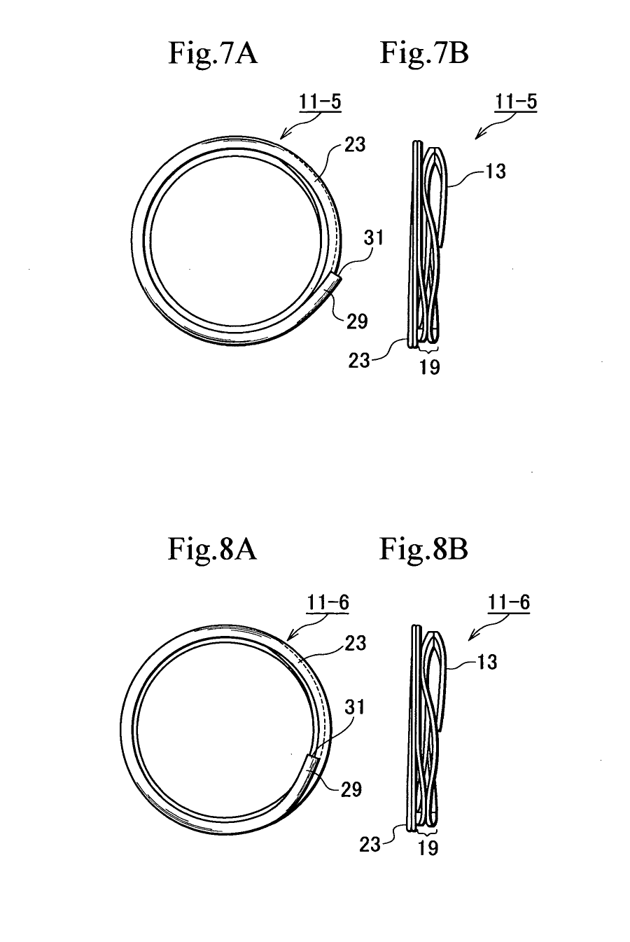

The wave spring 11-5 according to the fifth embodiment is an improvement of the engaging urging portion 23 according to the first embodiment upon varying its winding number of the spring 13 for the purpose of further improving the retaining ring functions which is to be achieved by the present invention. That is to say, in the wave spring 11-5 according to the fifth embodiment, the winding number of the spring 13 of the mounting portion 23 has been set to a plurality of times, for instance, substantially twice as shown in FIG. 7. In this case, the winding radius of the spring 13 of each time is arranged to be substantially identical to overlap each other. With this arrangement, coupled with the fact that the rigidity of the mounting portion 23 in increased, it is possible to achieve improvements in retaining ring functions.

### Sixth Embodiment

The wave spring 11-6 according to the sixth embodiment is an improvement of the engaging urging portion 23 according to the second embodiment upon varying its winding number of the spring 13 for the purpose of further improving the retaining ring functions which is to be achieved by the present invention. That is to say, in the wave spring 11-6 according to the sixth embodiment, the winding number of the spring 13 of the mounting portion 23 has been set to a plurality of times, for instance, substantially twice as shown in FIG. 8. In this case, the winding radius of the spring 13 of each time is arranged to be substantially identical to overlap each other. With this arrangement, coupled with the fact that the rigidity of the mounting portion 23 in increased, it is possible to achieve improvements in retaining ring functions, similar to the fifth embodiment.

### Seventh Embodiment

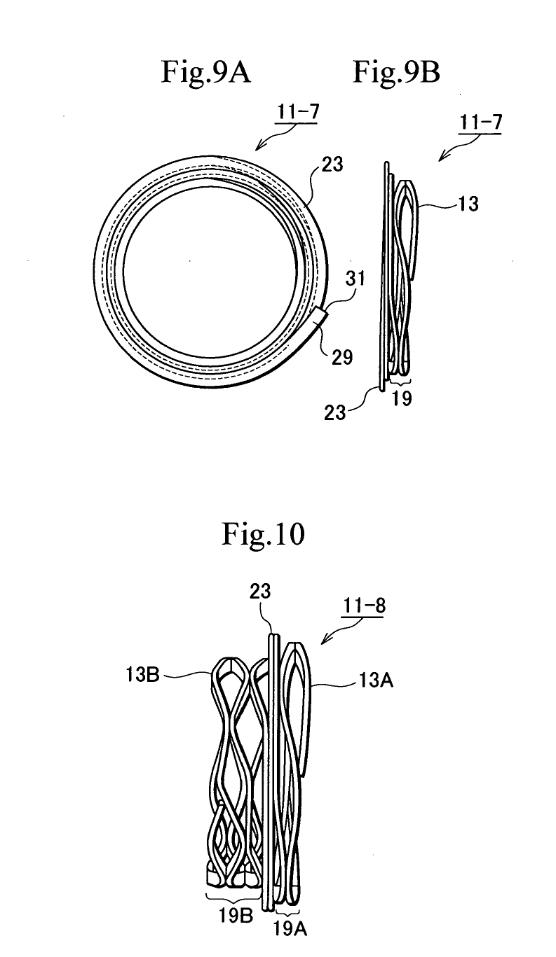

The wave spring 11-7 according to the seventh embodiment is an improvement of the fifth embodiment with the aim of preventing fitting of the wave portion 19 into the inner diameter of the mounting portion 23 in the wave spring 11-5 of the fifth embodiment when the outer diameter of the wave portion 19 is smaller than the inner diameter of the mounting portion 23. That is to say, in the wave spring 11-7 according to the seventh embodiment, the mounting portion 23 is arranged such that the winding radii of the spring 13 of each time are varied when forming the mounting portion 23 by winding the spring 13 twice along the winding peripheral direction as shown in FIG. 9. More particularly, the winding radius of the spring 13 of the mounting portion 23 is formed to gradually reduce such that it gradually approximates the outer diameter dimension of the wave portion 19 in coming closer to the wave portion 19 side.

In this manner, by forming the inner diameter of the mounting portion 23 such that it is reduced up to a dimension with which it does not allow fitting of the wave portion 19 therein anymore, fitting of the wave portion 19 into the inner diameter of the mounting portion 23 is prevented such that spring functions that the wave portion 19 is originally provided with can be effectively exhibited.

### Eighth Embodiment

The wave spring 11-8 according to the eighth embodiment is basically arranged in that two of the wave springs 11 according to the first embodiment are provided and connected such that respective mounting portions 23 are arranged back to back and such that one mounting portion 23 is provided at an intermediate spot of the wave springs as shown in FIG. 10.

In this case, the winding numbers of each of the springs 13A, 13B of the two wave portions 19A, 19B that are provided on both sides with the mounting portion 23 being pinched intermediately might be either same or different from each other. Further, the sizes of waveforms of the respective waves of the springs 13A, 13B might be either same of different from each other.

### Ninth Embodiment

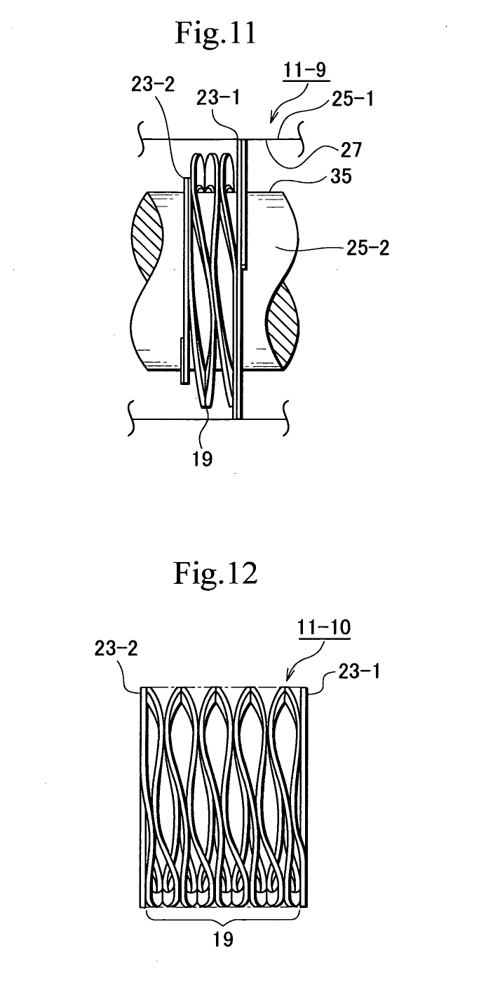

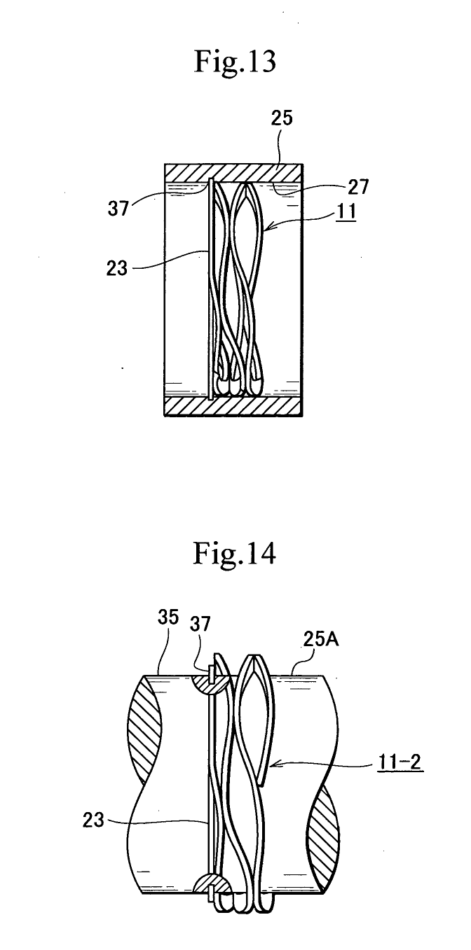

The wave spring 11-9 according to the ninth embodiment is a complex type of the wave springs according to the first and second embodiment, wherein a mounting portion 23-2 of the wave spring 11-2 according to the second embodiment is provided at a free end side different from mounting portion 23-1 of the wave spring 11 according to the first embodiment as shown in FIG. 11.

In the present wave spring 11-9, there are provided two mounting portions 23-1, 23-2 on both ends of the wave portion 19. By respectively mounting these mounting portions 23-1, 23-2 to two members to be mounted 25-1, 25-2, it is possible to achieve elastic coupling between both members to be mounted 25-1, 25-2. More particularly, while the mounting portion 23-1 is mounted to engage with the inner peripheral wall 27 of the cylindrical hollow axis 25-1 while elastically contacting the same, the mounting portion 23-2 is mounted to engage with the outer peripheral wall 35 of the axis member 25-2 while elastically contacting the same.

According to the ninth embodiment, it is possible to elastically couple two members to be mounted 25-1, 25-2.

### Tenth Embodiment

The wave spring 11-10 according to the tenth embodiment is an improvement of the ninth embodiment wherein the outer diameters of the mounting portions 23-1, 23-2 of the wave spring 11-9 according to the ninth embodiment are formed to be substantially identical to the outer diameter of the wave portion 19 as shown in FIG. 12.

According to the present wave spring 11-10, it is possible to elastically couple two members to be mounted by mounting the mounting portions 23-1, 23-2 provided on both ends of the wave portion 19 similar to the ninth embodiment.

### Other Embodiments

The wave spring 11 according to the present invention is arranged in that it can be easily mounted by preliminarily providing a circling mounting groove 37 at a portion to be mounted of the member to be mounted 25 such that the mounting portion 23 can be fit into the mounting groove 37.

More particularly, when mounting the wave spring 11 according to the first embodiment to the member to be mounted 25 which inner peripheral wall 27 is formed with the circling mounting groove 37, the outer diameter of the mounting portion 23, and particularly the engaging urging portion 29 is shrunk and moved or pushed along the inner peripheral wall 27 of the member 25 until the mounting groove 37 is reached. When the mounting portion 23 reaches the position of the mounting groove 37, elastic contacting force of the mounting portion 23 with respect to the outer radial direction is released in a single burst so that the mounting portion 23 is mounted to the member to be mounted 25. In this case, it is possible to make the mounting portion 23 elastically bit into a bottom wall of the mounting groove 37 in a condition in which the mounting portion 23 is fitted in the mounting groove 37.

Further, when mounting the wave spring 11 according to the second embodiment to the member to be mounted 25 which outer peripheral wall 35 is formed with the circling mounting groove 37, the inner diameter of the mounting portion 23, and particularly the engaging urging portion 33 is expanded and moved or pushed along the outer peripheral wall 35 of the member 25A until the mounting groove 37 is reached. When the mounting portion 23 reaches the position of the mounting groove 37, elastic contacting force of the mounting portion 23 with respect to the outer radial direction is released in a single burst so that the mounting portion 23 is mounted to the member to be mounted 25A. In this case, it is possible to make the mounting portion 23 elastically bit into a bottom wall of the mounting groove 37 in a condition in which the mounting portion 23 is fitted in the mounting groove 37.

According to the above other embodiments, where a circling mounting groove 37 is formed at a portion to be mounted of the member to be mounted 25, mounting can be easily performed by merely fitting the mounting portion 23 to the mounting groove 37.

In this respect, while wave springs according to the first and second embodiments have been illustrated for explaining examples for mounting the same to a mounting groove 37 in the above other embodiments, the scope of application of the present invention is not limited to such examples only. That is to say, embodiments in which one of the wave springs according to the third to seventh embodiments is attached to the mounting groove 37 instead of the wave springs according to the first or second embodiment are also included within the scope of the technical range of the claims according to the present invention.

The wave spring according to the present invention is mounted to a member to be mounted and is of improved retaining ring functions with respect to such a member to be mounted.

There exist various embodiments that apparently belong to the same scope of the present invention. Such various embodiments are not regarded to depart from the intention and scope of the present invention, and all such changes that are apparent to a person with ordinary skill in the art are included in the within the scope of the technical range of the claims according to the present invention.

What is claimed is:

1. A wave spring, in which a multiply annularly wound spring comprises a wave portion in which peaks and troughs are alternately formed in a winding peripheral direction and a ring-like mounting portion that is substantially flat in the winding peripheral direction, with an inner periphery or an outer periphery of the mounting portion being mounted upon engaging with an outer periphery or an inner periphery of an member to be mounted,
wherein the outer periphery or the inner periphery of the mounting portion is provided with an engaging urging portion which enables engagement through elastic contact with respect to a radial direction.

2. The wave spring as claimed in claim 1, wherein the engaging urging portion is arranged in that the spring is made to project towards the inner periphery or the outer periphery at suitably portions of the mounting portion.

3. The wave spring as claimed in claim 1, wherein the engaging urging portion is provided at an end portion and/or an intermediate portion of the mounting portion of the spring.

4. The wave spring as claimed in claim 2, wherein the engaging urging portion is provided at an end portion and/or an intermediate portion of the mounting portion of the spring.

5. The wave spring as claimed in claim 1, wherein the wave portion and the mounting portion are of mutually different winding radii.

6. The wave spring as claimed in claim 2, wherein the wave portion and the mounting portion are of mutually different winding radii.

7. The wave spring as claimed in claim 1, wherein the mounting portion is formed by winding the spring by a plurality of times.

8. The wave spring as claimed in claim 2, wherein the mounting portion is formed by winding the spring by a plurality of times.

9. The wave spring as claimed in claim 7, wherein the mounting portion is arranged in that each winding radius of the spring differs from time to time.

10. The wave spring as claimed in claim 8, wherein the mounting portion is arranged in that each winding radius of the spring differs from time to time.

11. The wave spring as claimed in claim 1, wherein the mounting portion is formed at any one of one end portion, an intermediate portion or both end portions of the spring.

12. The wave spring as claimed in claim 2, wherein the mounting portion is formed at any one of one end portion, an intermediate portion or both end portions of the spring.

13. The wave spring as claimed in claim 1, wherein a circling mounting groove is formed on the inner periphery or the outer periphery of the member to be mounted such that the mounting portion is mounted to the mounting groove.

14. The wave spring as claimed in claim 2, wherein a circling mounting groove is formed on the inner periphery or the outer periphery of the member to be mounted such that the mounting portion is mounted to the mounting groove.

15. The wave spring as claimed in claim 1, wherein the spring is formed of a strip-like base material.

16. The wave spring as claimed in claim 2, wherein the spring is formed of a strip-like base material.
